(19) United States
(12) Patent Application Publication
(10) Pub. No.: US 2004/0232604 A1
(43) Pub. Date: Nov. 25, 2004

(54) Method and apparatus for injection molding

(76) Inventors: Steven Andrew Jordan, Staffordshire (GB); Kenneth Richard Crow, West Indian (GB); Ulrich Stieler, Goslar (DE); Jonathan Michael Butler, Cheshire (GB)

Correspondence Address: John A Artz, Artz & Artz, 28333 Telegraph Road, Suite 250, Southfield, MI, 48034, US

(21) Appl. No.: 10/475,883

(22) PCT Filed: Apr. 22, 2002
(86) PCT No.: PCT/GB02/01869

(30) Foreign Application Priority Data
Apr. 26, 2001 (GB) 0110263.1

(51) Int. Cl. B29C 47/00

(52) U.S. Cl. 264/572; 425/130

(57) ABSTRACT

A method and apparatus for producing an injection moulded plastics article comprises introducing a supply of plastics material (20) into a mould space (13), supplying a first stream of pressurised fluid into the molten plastics material to form a fluid containing cavity (25) therein, maintaining fluid pressure in the cavity until the plastics material can sustain the form dictated by the mould surface. During the step of maintaining fluid pressure in the cavity, at least a portion of the first stream of pressurised fluid is vented or allowed to vent from the cavity, and simultaneously a second stream of pressurised fluid from a second source (26; 40; 41) is supplied to the cavity, which second stream replaces that portion of the first stream which has vented from the cavity.

### METHOD AND APPARATUS FOR INJECTION MOULDING

This invention relates to a method and apparatus for injection moulding.

It is known to produce an injection moulded plastics article by introducing a supply of plastics material through an injection aperture into a mould space, and supplying a stream of pressurised fluid, normally nitrogen, through an inlet into the interior of the molten plastics material to form a fluid containing cavity therein. Fluid pressure in the cavity is maintained until the plastics material has solidified and cooled sufficiently so that the article can sustain the form dictated by the mould surface. Venting the fluid pressure in the cavity to atmospheric pressure takes place before the mould is opened to remove the article.

It is also known to lower the fluid pressure in the fluid containing cavity during the step of maintaining, by venting a portion of the fluid from the cavity. However, the cooling time of the plastics material in the mould space is dependent on loss of heat through the mould walls.

An object of the invention is to reduce the cooling time before venting the fluid containing cavity so that the mould can be opened.

According to the invention there is provided a method of producing an injection moulded plastics article comprising introducing a supply of plastics material through an injection aperture into a mould space, supplying a first stream of pressurised fluid through an inlet into the interior of the molten plastics material to form a fluid containing cavity therein, maintaining fluid pressure in the cavity until the plastics material has solidified and cooled sufficiently so that the article can sustain the form dictated by the mould surface, and venting or allowing fluid to vent from the cavity before opening the mould, characterised in that during the step of maintaining fluid pressure in the cavity, at least a portion of the first stream of pressurised fluid is vented or allowed to vent from the cavity, and simultaneously a second stream of pressurised fluid from a second source is supplied to the cavity, which second stream replaces that portion of the first stream which has vented from the cavity.

Preferably the step of supplying the second stream of pressurised fluid to the cavity is continued whilst simultaneously venting fluid from the cavity, thereby creating a flow of fluid through the cavity.

It is also preferred that the rate of flow through the cavity is controlled to assist the plastics material to cool whilst maintaining sufficient fluid pressure in the cavity. In one embodiment the rate of flow of fluid through the cavity is controlled by control means which control the input and/or output of fluid to maintain a desired fluid pressure within the cavity whilst maintaining a fluid flow through the cavity. For example, the input of fluid may be set at a higher pressure than the output of fluid. Alternatively, the control means may be set to create a constant fluid pressure within the cavity with varied flow rate at a preset temperature.

The first and second fluids are preferably different fluids. In one embodiment the first fluid is nitrogen, whilst the second fluid is preferably compressed air or liquid, e.g. water.

In one embodiment, the second fluid is the same fluid as the first fluid, but is supplied at a different pressure and/or temperature from that of the first fluid. In this case, both the first fluid and the second fluid are nitrogen.

The first fluid may be recirculated to provide the second stream of fluid. The first fluid may be recirculated through cooling means.

In the case of the second fluid being a liquid, a third stream of pressurised fluid is preferably supplied to the cavity, the third stream being a gas which purges the cavity of the second fluid.

The second fluid may be supplied to the cavity at a cooler temperature than the first fluid. If desired, the second fluid is pre-chilled before being supplied.

In one embodiment, the second stream is supplied to flow between supply and vent positions in substantially the opposite direction to that of the first stream.

The invention also provides apparatus for producing an injection moulded plastics article comprising means for introducing a supply of plastics material through an injection aperture into a mould space, means for supplying a first stream of pressurised fluid through an inlet into the interior of the molten plastics material to form a fluid containing cavity therein, and means for venting the fluid from the cavity, wherein the apparatus includes means for supplying a second stream of pressurised fluid from a second source to said inlet or another inlet simultaneously to venting at least a portion of the first fluid within the cavity, the vent means for the first fluid being spaced from the inlet for said second stream of pressurised fluid.

In a preferred embodiment the inlet for the first stream of pressurised fluid is positioned substantially at or near the upstream end of the mould space in the direction of flow of the plastics material, and the vent means are positioned substantially at or near the downstream end of the mould space.

The inlet or inlets may be adapted to be connected, in use, to two sources of different pressurised fluids comprising the first and second fluids respectively.

Preferably means are provided for controlling the rate of venting the first fluid from the cavity relative to the rate of input of the second stream of pressurised fluid, to maintain a sufficient fluid pressure within the cavity whilst maintaining a fluid flow through the cavity.

It is also preferred that the control means control the input and/or output of fluid to maintain a desired fluid pressure within the cavity.

In one embodiment, the input of fluid is set at a higher pressure than the output of fluid. Alternatively, the control means may be set to create a constant fluid pressure within the cavity with varied flow rate at a preset temperature.

In the case of the second fluid being a liquid, means are preferably provided for supplying a third stream of pressurised fluid to an inlet, the third fluid being a gas to purge the cavity of the second fluid.

Means may be provided for pre-chilling the second fluid.

Means may be provided for recirculating the first fluid to provide the second stream of fluid. The recirculation means may include cooling means.

By way of example, specific embodiments in accordance with the invention will be described with reference to the accompanying diagrammatic drawings in which:

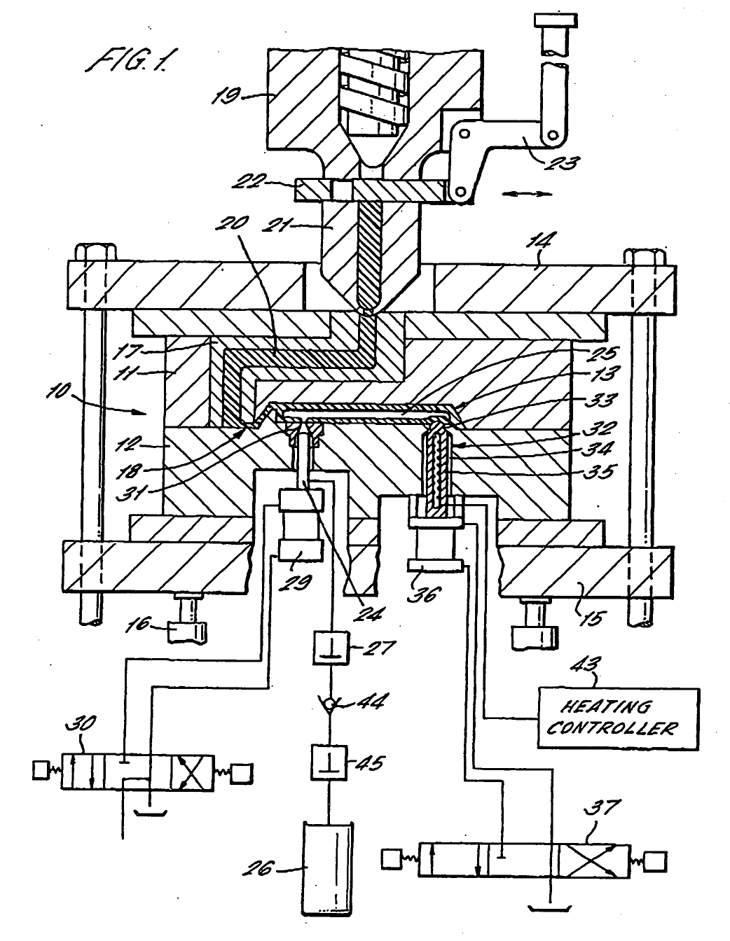

FIG. 1 shows an apparatus for injection moulding a plastics article illustrating one of a plurality of nozzles for supplying separate streams of pressurised fluid in succession near the upstream end of the mould space in the direction of flow of the plastics material, and a vent pin near the downstream end of the mould space;

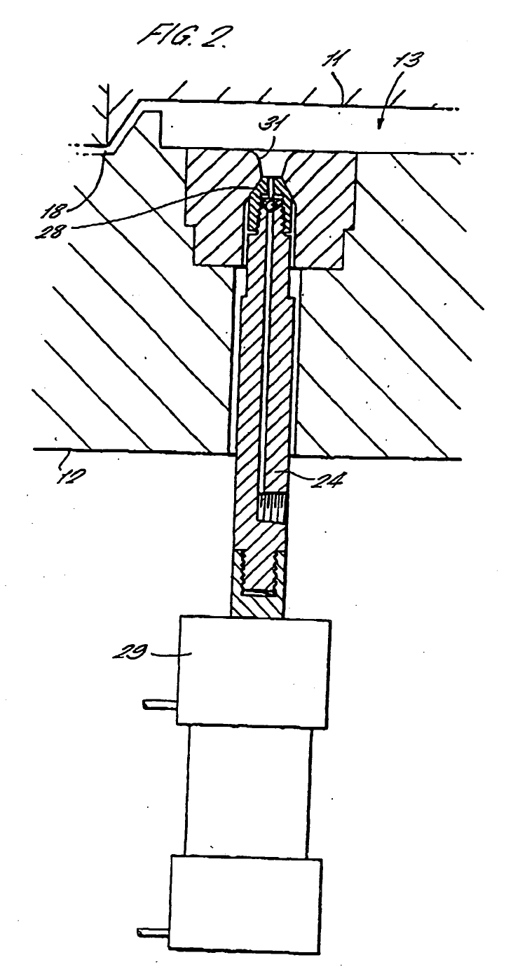

FIG. 2 illustrates one of the fluid supply nozzles of FIG. 1 in its extended position before plastics material is introduced into the mould space;

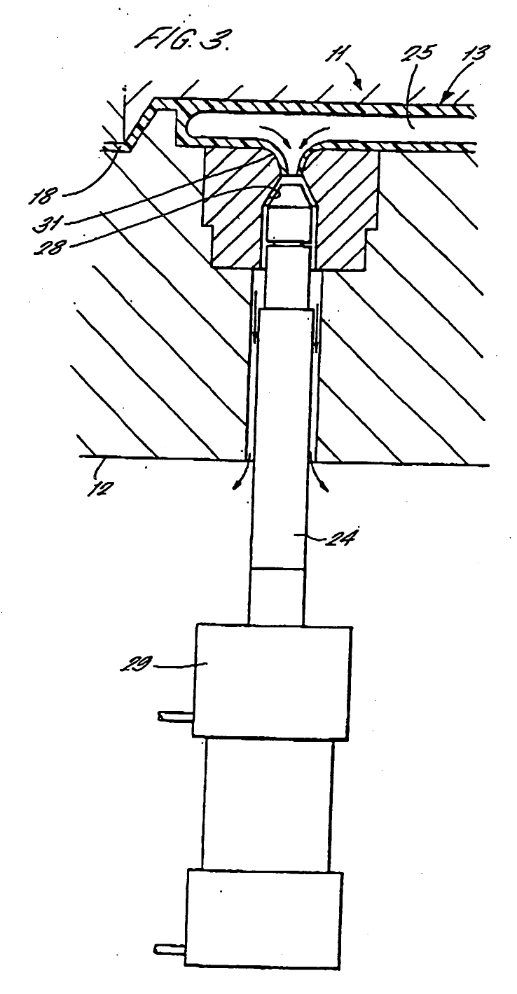

FIG. 3 illustrates the fluid supply nozzle of FIG. 2 in its withdrawn position in which fluid vents from the fluid containing cavity;

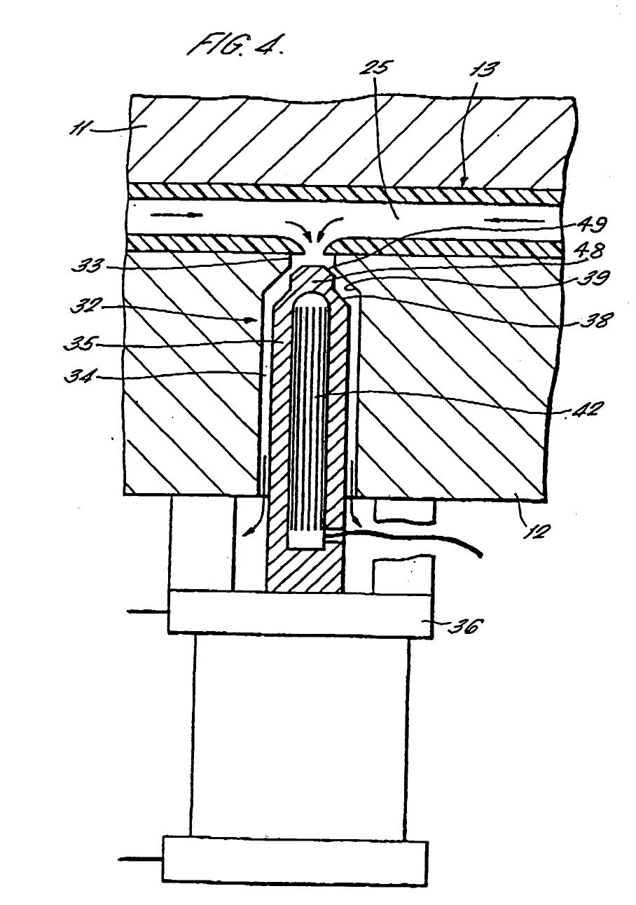

FIG. 4 illustrates the vent pin of FIG. 1 in its withdrawn position in which fluid vents from the fluid containing cavity;

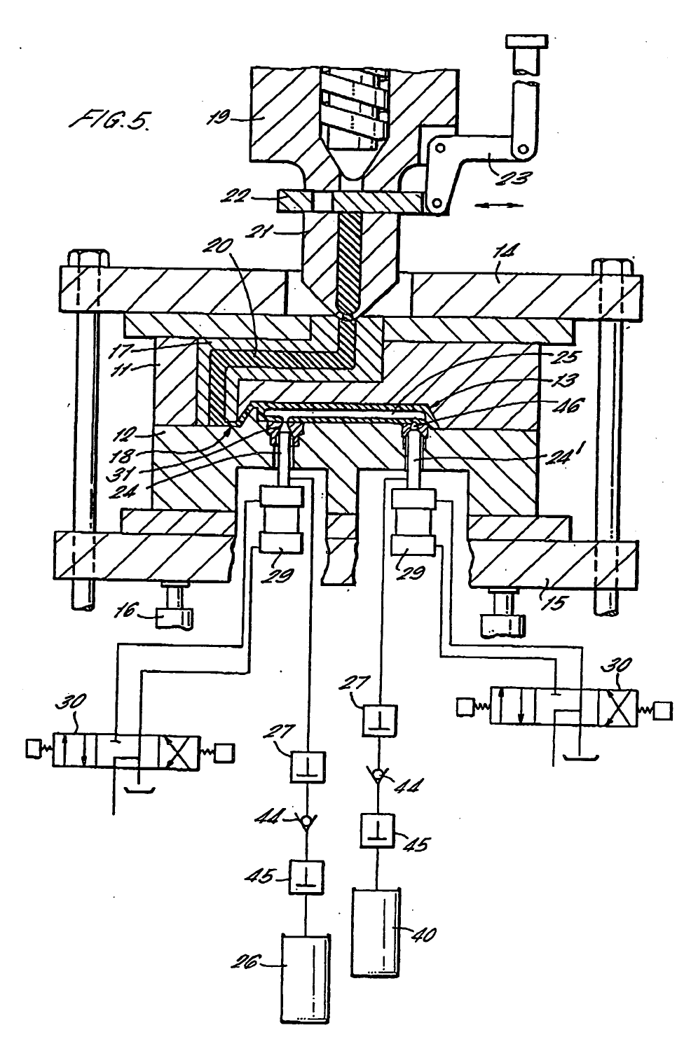

FIG. 5 shows another embodiment in which there is provided a fluid supply nozzle near the upstream end of the mould space and the vent pin hear the downstream end of the mould space is replaced by a second nozzle for supplying and, if desired, venting fluid; and

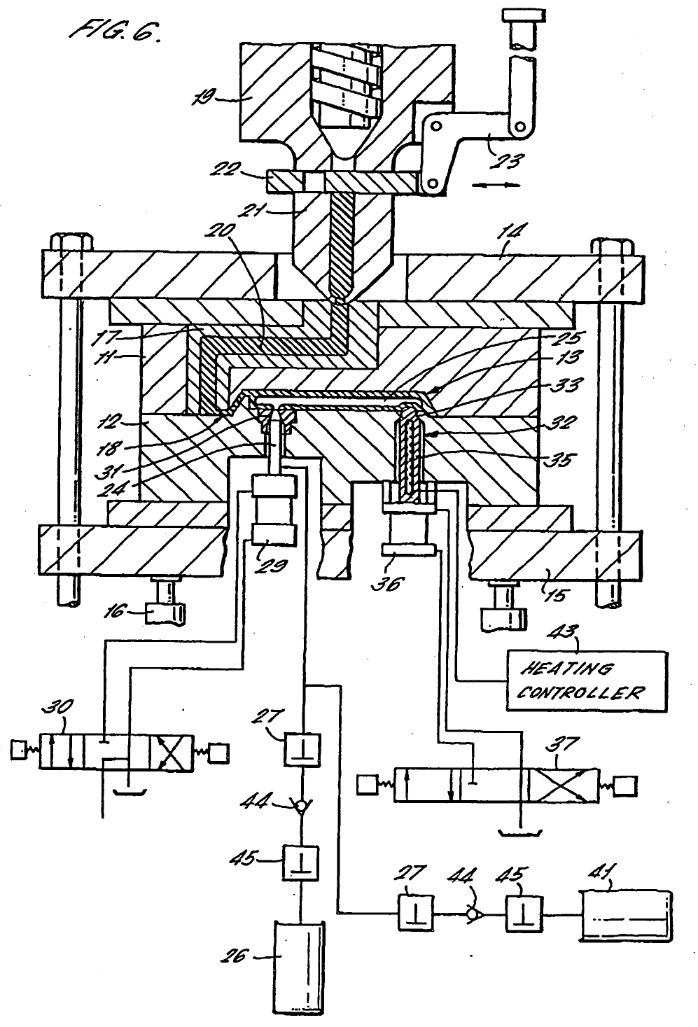

FIG. 6 shows an alternative embodiment to FIG. 1 in which a single fluid supply nozzle is connected to at least two different sources of pressurised fluid.

This example concerns an apparatus for producing an injection moulded plastics article. The apparatus provides a screw ram for introducing into a mould space an amount of plastics material sufficient for producing the article. A fluid nozzle is provided to supply pressurised fluid into the interior of the plastics material in the mould space to create a fluid containing cavity in the plastics material. Fluid pressure is maintained in the cavity until the plastics material has solidified and cooled sufficiently so that the article can sustain the form dictated by the mould surface. Valve means are also provided which when opened relieve the fluid pressure within the fluid containing cavity before the mould is opened to remove the article. The positions for introducing the pressurised fluid and for relieving the fluid pressure may be varied, but generally they are spaced apart in the direction of flow of the plastics material. Conveniently, the fluid nozzle is positioned substantially at or near the upstream end of the mould space, and the valve means for venting fluid from the fluid containing cavity is positioned substantially at or near the downstream end of the mould space.

Referring to FIG. 1, a mould 10 of an injection moulding machine has upper and lower parts 11, 12 defining a mould space 13. The mould parts 11, 12 are mounted between a fixed upper platen 14 and a lower platen 15 movable by a hydraulic ram 16. Also, in this embodiment, within the upper mould part 11 is a hot runner manifold 17 leading to an injection aperture or gate 18 to the mould space 13.

A screw ram 19 is provided for introducing molten thermoplastics material 20 through a nozzle assembly 21 to the hot runner manifold 17 and through the gate 18 into the mould space 13. The nozzle assembly is provided with a shut-off slide valve 22 actuated by a bell-crank lever 23. The valve 22 is shown in its closed position at the end of the mould cycle which includes the introduction of the plastics material. The screw ram may then be refilled with plastics material in preparation for the next moulding cycle.

A first fluid nozzle 24 is provided for supplying a first stream of pressurised fluid through an inlet opening 31 near the upstream end of the mould space 13 in the direction of flow of the plastics material 20 to create a fluid containing cavity 25 in the plastics material. In this embodiment, the fluid is a gas, preferably nitrogen. The nozzle 24 is connected to a supply source 26 of nitrogen via a control valve 27, a non-return valve 44 and a pressure regulator 45. The nozzle 24 may be a fixed nozzle mounted in the lower part 12 of the mould 10, or, as in this embodiment, it is a movable nozzle of the kind which is known from European Patent No. 0283207. A piston and cylinder 29 is controlled via a solenoid operated valve 30 by control means (not shown) to move the nozzle 24 between a forward position (FIG. 2), and a withdrawn position (FIG. 3). In the forward position, the nozzle 24 is in sealing engagement with a conical valve seat 28 of a valve port opening directly into the mould space at the opening 31. In the withdrawn or valve port open position of the nozzle 24, gas pressure within the cavity is relieved through the opening 31, the gas passing around the nozzle 24 to atmosphere.

A second fluid supply nozzle 24 is also provided near the upstream end of the mould space 13 for supplying a second stream of pressurised fluid into the cavity 25. In this embodiment, the second fluid is compressed air supplied to the second nozzle 24 from a respective source 26. In another embodiment, the second fluid is nitrogen gas, like the first fluid, but supplied to the nozzle 24 from a respective source 26 at a different pressure and/or temperature from the first fluid. In this case, the source for the second fluid may be means for recirculating the first fluid vented from the cavity, but at a different pressure and/or temperature from the first fluid. For example, the fluid may be recirculated through cooling means.

In a further embodiment, the second fluid is a liquid, e.g. water. In this case, a third fluid supply nozzle 24 is provided near the upstream end of the mould space 13 and connected to a respective source 26. This third nozzle 24 supplies a third stream of pressurised fluid which is a gas, e.g. compressed air, into the cavity 25. The third stream is used to purge the cavity 25 of the second fluid. The third fluid may also be a repeat burst of the first fluid if the first fluid is a gas, for example, nitrogen. In either case, the gas is supplied from its own respective source 26 at a desired pressure and/or temperature.

Near the downstream end of the mould space 13, but not beyond the extreme end of the gas-containing cavity 25, there is provided separate valve means 32 for relieving or venting gas from the cavity through an outlet opening 33 and passage 34 in the lower part 12 of the mould 10. In this embodiment, the valve means 32 is of a similar kind to the valve means known from European Patent No. 0309257. The valve means 32 is a retractable closure or pin 35 of smaller diameter than the bore of the vent passage 34, the pin extending lengthwise of the vent passage and being carried by a piston and cylinder 36 operated hydraulically or pneumatically by a solenoid operated control valve 37. The piston and cylinder 36 moves the pin 35 between extended and retracted positions. The pin 35 has a cylindrical extension or head 48 with a chamfered or pointed tip 49 (best shown in FIG. 4), which in the extended position of the pin 35 (FIG. 1) projects into the mould space 13 to assist the creation of an outlet path between the cavity 25 and the vent passage 34 when the pin is withdrawn (FIG. 4). Also, in the extended position of the pin, a conical surface 38 of the pin engages a correspondingly shaped valve seat 39 thereby closing the vent passage 34 at its inner end which is also substantially blocked by the leading end of the pin. In this embodiment, within a bore in the pin 35, there is optionally provided a cartridge heater 42 for maintaining the pin at a desired temperature, especially at its leading end. Control of the heater is by means of a heating controller 43. The leading end of the pin 35 may be formed in any of the ways previously described and illustrated in FIGS. 2 to 5 of European Patent No. 0309257. In each case, when the pin 35 is withdrawn (FIG. 4), the pressure of the gas in the gas-containing cavity breaks through the plastics wall and/or the act of retracting the pin shears through the plastics wall to create a vent hole therein through which the gas passes to atmosphere.

The extent to which the pin 35 is withdrawn, towards its extreme withdrawn position may be varied by valve means (not shown) to control the rate of venting the gas from the cavity 25. The rate of venting relative to the input of gas is controlled to maintain the desired gas pressure within the cavity whilst at the same time creating a gas flow through the cavity. In this embodiment the nozzle 24 controlling the input of gas is set at a higher pressure than the outlet valve means 32.

Alternatively, the respective control means can be varied to create a constant pressure within the cavity 25 with varied flow rate at a preset temperature. This is achieved by providing a closed loop system in which temperature and pressure transducers, control means and valve means control the flow of vented gas such that the temperature of the vented gas is maintained according to a preset temperature profile.

The supply means for the first fluid or second fluid may include a cooling apparatus, e.g. refrigeration means, for lowering the temperature of the fluid before it is supplied to the cavity 25 through the respective inlet opening.

In another embodiment (FIG. 5), a first fluid supply nozzle 24 is provided near the upstream end of the mould space as shown in FIG. 1. The vent pin 35 illustrated in FIG. 1 is replaced by a second fluid supply nozzle 24′ of the movable kind described above, and connected to a second supply 40 of pressurised fluid via a control valve 27, a non-return valve 44 and a pressure regulator 45. The second fluid is preferably compressed air, but may be a liquid, e.g. water. The leading end of the nozzle 24′ has a cylindrical extension with a pointed tip which, in the extended position of the nozzle as shown, projects into the mould space 13. The extended end 46 of the nozzle assists the second fluid to pierce a hole in the skin of plastics material and flow into the fluid containing cavity 25. The extended end also allows the second fluid to be introduced at a lower pressure than the pressure at which the first fluid is introduced by the upstream nozzle 24 to create the fluid containing cavity 25.

As above, the second fluid may be pre-chilled by refrigeration means (not shown) before being supplied to the second fluid nozzle 24′.

FIG. 6 shows a further embodiment which is similar to the embodiment of FIG. 1 except that a single fluid supply nozzle 24 is connected to two different supplies 26, 41 of pressurised fluid. In this case, the first fluid supply 26 is nitrogen and the second fluid supply 41 is compressed air or a liquid, e.g. water. Each connection of the nozzle 24 to the respective supply includes a control valve 27, a non-return valve 44 and a pressure regulator 45. Again the second fluid may be pre-chilled by refrigeration means (not shown) before being supplied to the fluid supply nozzle 24.

In each embodiment, operation of the screw ram 19 introduces a partial or full shot of molten plastics material through hot runner manifold 17 and injection aperture or gate 18 into the mould space 13. Simultaneously, a gas delay timer is started. At the end of this delay time, the outlet end of the first fluid supply nozzle 24 is immersed in plastics material. Valve 27 is opened and a first stream of nitrogen is supplied from supply 26 to the nozzle 24 and into the interior of the plastics material in the mould space 13 to create the gas containing cavity 25 in the plastics material in known manner. The pressurised gas causes the plastics material to fill the mould space in the case of a partial shot, and subsequently provides an outward pressure on the surrounding plastics material to maintain the plastics material in contact with the mould wall to counteract the shrinkage of the plastics material as it cools and solidifies, and thereby prevent sink marks on the external surface of the resultant moulding. Gas pressure is maintained throughout the cooling period.

In accordance with the embodiment of FIG. 1, during the step of maintaining, the valve means 32 is opened by retracting pin 35. An outlet passage is thereby created through the wall of the plastics material between the cavity 25 and the vent passage 34, so that gas can vent from the cavity to atmosphere. Either the gas breaks through the wall of plastics under its own pressure, or due to the special form of head of the pin, for example, as shown in FIG. 4 of European Patent No. 0309257, the act of retracting the pin shears through the plastics wall to create a vent hole therein through which the gas passes to atmosphere. Simultaneously, with the valve means 32 still open, the first stream of nitrogen is shut off by closing valve 27, and a second stream of fluid, for example, compressed air, is supplied through the second fluid supply nozzle 24 from its respective source 26, to maintain sufficient gas pressure within the gas containing cavity to counteract the tendency for the plastics material to shrink away from the wall of the mould space 13. At this stage the plastics material is not self-supporting. The gas pressure maintained within the cavity 25 may be at the same pressure or at a lower pressure than that which created the gas containing cavity, and likewise the second stream of gas may be supplied at the same pressure or at a lower pressure than the first stream of gas.

By supplying the second stream of gas through the second nozzle 24 simultaneously to venting gas from the cavity 25, there is created a gas flow through the cavity which assists the plastics material to cool, thereby reducing the time period of the cooling stage.

At the end of the cooling stage, i.e. when the plastics material has cooled and can maintain the form dictated by the mould surface, the second gas stream is terminated by closing the respective valve 27 and the vent pin 35 is held retracted whereby the gas pressure in the gas containing cavity 25 is reduced to atmospheric pressure. Additionally, if desired, since each gas supply nozzle 24 is of the movable kind, one or each of the nozzles 24 can be retracted (FIG. 3) to assist the venting of the cavity 25 and thereby reduce the time period of the venting stage. After venting, the mould is opened to remove the article.

The apparatus illustrated in FIG. 5 allows a variation of the above method, whereby the second stream of fluid is supplied through nozzle 24′ near the downstream end of the mould space in the direction of flow of the plastics material, and the nozzle 24 near the upstream end is retracted to vent fluid from the cavity 25. The direction of flow of the second stream of fluid through the cavity 25 is thereby in the opposite direction to the first stream of fluid. In this case, the first stream of fluid via nozzle 24 may be nitrogen, and the second stream of fluid via nozzle 24′ may be compressed air. The compressed air can be supplied at a lower pressure than the nitrogen, particularly due to the extended leading end 46 of the nozzle 24′ assisting the air to pierce through the skin of plastics material covering the nozzle 24′ so that the stream of air can enter the cavity 25. At the end of the cooling stage, the cavity 25 is vented by either or both nozzles 24, 24′ being retracted.

A further variation may be achieved by operating the apparatus illustrated in FIG. 6. In this case, the first stream of fluid, e.g: nitrogen, is supplied from supply source 26 to nozzle 24 to create the fluid containing cavity 25. During the step of maintaining, the vent pin 35 is retracted to vent fluid from the cavity 25 in the manner described above in connection with FIGS. 1 to 4, whilst simultaneously a second stream of fluid from the second supply source 40, e.g. compressed air, is supplied to the cavity through nozzle 24. As above, the second stream of fluid may be supplied at the same pressure or at a lower pressure than the first stream of fluid. At the end of the cooling stage the cavity is vented by retaining the pin 35 retracted and if desired retracting the nozzle 24.

In each of the above embodiments, simultaneously replacing the first fluid in the cavity by the second stream of fluid achieves a reduction in the time period of the cooling stage. The first and second fluids may be different fluids supplied from separate sources, or may be the same fluid supplied from separate sources, in which the fluid from the second source is supplied at a different pressure and/or temperature to that of the fluid from the first source.

Additionally, in the case of the variations described above in which the second supply of fluid is pre-chilled before being supplied to the cavity 25, a further reduction in the time of the cooling stage can be achieved.

Furthermore, as indicated above, when using a liquid as the second fluid during the cooling stage, it is advantageous to supply a subsequent charge of pressurised gas, as a third stream of fluid, into the cavity 25 to purge the cavity of the second fluid thereby leaving the cavity dry or substantially dry. This avoids having to provide some other means of removing the cooling liquid from the cavity 25 after the moulding cycle is complete, i.e. after the mould has been opened to remove the article.

In the embodiments of FIGS. 5 and 6, the third stream of fluids whether it is nitrogen, compressed air or other gas, may be a further injection of the first fluid from source 26 via the first supply nozzle 24. The third stream may be at the same pressure or at a lower pressure than the first stream.

The invention is not restricted to the specific details of the embodiments described above. For example, as stated above, the position of the or each fluid nozzle 24, 24′ and/or the valve means 32 may be at any desired position providing that the inlet for the second stream of fluid and the means for simultaneously venting fluid from the cavity 25 are spaced apart to provide a flow of fluid through the mould space 13 to assist the cooling of the plastics material.

Also, with regard to the embodiment of FIG. 1 or FIG. 6, the valve means 32 as illustrated may be replaced by valve means comprising a reciprocal pin which is moved forward to pierce a hole through the plastics wall to allow venting to take place in a controlled manner, rather than being withdrawn to allow venting to take place in the manner described above.

Further it is possible to provide the gas supply nozzle for at least the first stream of fluid, upstream of the mould space, for example, as illustrated in FIG. 4 of European Patent No. 0283207 or FIG. 1 of European Patent No. 0309257.

1. A method of producing an injection moulded plastics article comprising introducing a supply of plastics material through an injection aperture into a mould space, supplying a first stream of pressurised fluid from a first source through an inlet into the interior of the molten plastics material to form a fluid containing cavity therein, maintaining fluid pressure in the cavity until the plastics material has solidified and cooled sufficiently so that the article can sustain the form dictated by the mould surface, and venting or allowing fluid to vent from the cavity before opening the mould, characterised in that during the step of maintaining fluid pressure in the cavity, at least a portion of the first stream of pressurised fluid is vented or allowed to vent from the cavity, and simultaneously a second stream of pressurised fluid from a second source is supplied to the cavity, which second stream replaces that portion of the first stream which has vented from the cavity.

2. A method as claimed in claim 1, wherein the step of supplying the second stream of pressurised fluid to the cavity is continued whilst simultaneously venting fluid from the cavity, thereby creating a flow of fluid through the cavity.

3. A method as claimed in claim 2, wherein the rate of flow through the cavity is controlled to assist the plastics material to cool whilst maintaining sufficient fluid pressure in the cavity.

4. A method as claimed in claim 2 or claim 3, wherein the rate of flow of fluid through the cavity is controlled by control means which control the input and/or output of fluid to maintain a desired fluid pressure within the cavity whilst maintaining a fluid flow through the cavity.

5. A method as claimed in claim 4, wherein the input of fluid is set at a higher pressure than the output of fluid.

6. A method as claimed in claim 4, wherein the control means are set to create a constant fluid pressure within the cavity with varied flow rate at a preset temperature.

7. A method as claimed in any one of the preceding claims, wherein the first and second fluids are different fluids.

8. A method as claimed in claim 7, wherein the first fluid is nitrogen, and the second fluid is compressed air or a liquid.

9. A method as claimed in any one of claims 1 to 6, wherein the second fluid is the same fluid as the first fluid, but is supplied at a different pressure and/or temperature from that of the first fluid.

10. A method as claimed in claim 9, wherein both the first fluid and the second fluid are nitrogen.

11. A method as claimed in claim 9, wherein the first fluid is recirculated to provide the second stream of fluid.

12. A method as claimed in claim 11, wherein the first fluid is recirculated through cooling means.

13. A method as claimed in any one of the preceding claims, wherein the second fluid is a liquid, and a third stream of pressurised fluid is supplied to the cavity, the third stream being a gas which purges the cavity of the second fluid.

14. A method as claimed in any one of the preceding claims, wherein the second fluid is supplied to the cavity at a cooler temperature than the first fluid.

15. A method as claimed in claim 12, including the step of pre-chilling the second fluid before supplying the second fluid.

16. A method as claimed in any one of the preceding claims, wherein the second stream is supplied to flow between supply and vent positions in substantially the opposite direction to that of the first stream.

17. Apparatus for producing an injection moulded plastics article comprising means for introducing a supply of plastics material through an injection aperture into a mould space, means for supplying a first stream of pressurised fluid from a first source through an inlet into the interior of the molten plastics material to form a fluid containing cavity therein, and means for venting fluid from the cavity, wherein the apparatus includes means for supplying a second stream of pressurised fluid from a second source to said inlet or another inlet simultaneously to venting at least a portion of the first fluid within the cavity, the vent means for the first fluid being spaced from the inlet for said second stream of pressurised fluid.

18. Apparatus as claimed in claim 17, wherein said inlet for said first stream of pressurised fluid is positioned substantially at or near the upstream end of the mould space in the direction of flow of the plastics material, and the vent means for the first fluid are positioned substantially at or near the downstream end of the mould space.

19. Apparatus as claimed in claim 17 or claim 18, wherein said inlet or inlets are adapted to be connected, in use, to two sources of different pressurised fluids comprising said first and second fluids respectively.

20. Apparatus as claimed in any one of claims 17 to 19, including means for controlling the rate of venting the first fluid from the cavity relative to the rate of input of the second stream of pressurised fluid, to maintain a sufficient fluid pressure within the cavity whilst maintaining a fluid flow through the cavity.

21. Apparatus as claimed in claim 20, wherein said control means control the input and/or output of fluid to maintain a desired fluid pressure within the cavity.

22. Apparatus as claimed in claim 21, wherein the input of fluid is set at a higher pressure than the output of fluid.

23. Apparatus as claimed in claim 21, wherein the control means are set to create a constant fluid pressure within the cavity with varied flow rate at a preset temperature.

24. Apparatus as claimed in any one of claims 17 to 23, wherein the first fluid is nitrogen, and the second fluid is compressed air or a liquid.

25. Apparatus as claimed in any one of claims 17 to 23, wherein the second fluid is the same fluid as the first fluid, but is supplied at a different pressure and/or temperature from that of the first fluid.

26. Apparatus as claimed in any one of claims 17 to 24, wherein the second fluid is a liquid, and means are provided for supplying a third stream of pressurised fluid to an inlet, the third fluid being a gas to purge the cavity of the second fluid.

27. Apparatus as claimed in any one of claims 17 to 26, including means for pre-chilling the second fluid.

28. Apparatus as claimed in claim 23, wherein means are provided for recirculating the first fluid to provide the second stream of fluid.

29. Apparatus as claimed in claim 28, wherein the recirculation means includes cooling means.
